(19) United States
(12) Patent Application Publication
(10) Pub. No.: US 2010/0300095 A1
(43) Pub. Date: Dec. 2, 2010

(54) SEA SURFACE COOLING SYSTEM UTILIZING OTEC

(76) Inventor: Toshihiko SAKURAI, Tokorozawa-shi (JP)

Correspondence Address: OLIFF & BERRIDGE, PLC, P.O. BOX 320850, ALEXANDRIA, VA, 22320-4850, US

(21) Appl. No.: 12/855,290

(22) Filed: Aug. 12, 2010

(30) Foreign Application Priority Data
Feb. 22, 2010 (JP) 2010-055091
Jun. 10, 2010 (JP) 2010-146851

(51) Int. Cl. F03G 7/04

(52) U.S. Cl. 60/641.7

(57) ABSTRACT

A sea surface cooling system utilizing OTEC of the present invention comprises means for drawing surface seawater, deep seawater pumping means for pumping deep seawater through a draw pipe, evaporator means for heating and vaporizing working fluid with a low boiling point by said drawn surface seawater, mechanical power producing means for producing mechanical power by expansion force of said vaporized working fluid, condensation means for cooling said vaporized working fluid after said expansion by said pumped deep seawater to cause condensation, and means for circulating said condensed working fluid to said evaporator means. The system is characterized by including mechanical power transmission means for directly transmitting from said mechanical power producing means to said pumping means a mechanical power of variable ratio, without once converting said mechanical power into electric power.

### BACKGROUND OF THE INVENTION

1. Field of the Invention

This invention relates in general to a sea surface cooling system, and particularly to a system that utilizes OTEC (Ocean Thermal Energy Conversion) to generate mechanical power for pumping cool deep seawater upward for cooling the hot sea surface.

2. Description of Related Art

Recently, various clean power generating systems have been developed to utilize a variety of natural energy resources other than conventional fossil fuels because fossil fuels emit carbon dioxide (CO₂), a harmful greenhouse gas that promotes global warming. These clean energy resources include solar energy, wind energy, wave energy, tidal energy, and ocean thermal energy. The present inventor has previously filed a patent application titled Solar Power Generating System Employing a Solar Battery (US20100018567).

In a power generation system utilizing OTEC, the temperature difference between hot surface seawater and cold deep seawater is utilized to generate electric power. In a typical closed cycle, a working fluid of a low boiling point such as ammonia is heated in an evaporator by the hot surface seawater and converted to vapor for driving a turbine. Subsequently, the vaporized working fluid is cooled in a condenser by the cold deep seawater and converted back to liquid and is circulated back to the evaporator. The mechanical power of the turbine thus produced is converted into electric power by a generator. A part of the electric power thus produced is used to drive a pump for drawing deep seawater and the surface seawater into the system. The rest is supplied outside as a net electric power produced in the system.

OTEC power generation works at considerably lower temperatures than conventional steam power generation. Consequently, an energy conversion efficiency is considerably lower than that in conventional steam power generation. This low conversion efficiency is due to a principle of thermodynamics that makes any significant improvement in efficiency unlikely.

To offset this low conversion efficiency, multipurpose OTEC for incorporates additional functions such as freshwater production has been examined. However, commercial power plants employing OTEC appear to be lagging behind clean energy power plants utilizing other types of natural energy resources.

The efficiency of power generation utilizing any of the various clean energy resources described above is lower than that of conventional steam power generation. Nevertheless, power generation systems utilizing clean energy resources have been developed with the primary objective of reducing CO₂ rather than achieving highly efficient energy conversion. However, this objective is based on the premise that reducing CO₂ is the most effective way to prevent global warming. The present inventor has a different view of our current situation and believes that the premise itself is no longer accurate.

This means that, while global warming continues to progress due primarily to CO₂ as the main greenhouse gas, there is a frightening possibility that thermal runaway awaits in the future, whereby water vapor would replace CO₂ as the predominant greenhouse gas. In other words, reducing CO₂ emissions is no longer the best way to prevent thermal runaway. Rather, it will be necessary to take more dependable measures to cool the global surface, and particularly the sea surface, directly.

Various plans for cooling the global surface have been considered, including a plan to produce artificial clouds, especially maritime cumuli at low altitudes, or to increase the thickness of such clouds in order to prevent sunlight from reaching the sea surface and heating it. For this purpose, a technique for producing artificial precipitation can be applied.

However this application will be somewhat more difficult than producing artificial precipitation in the sense that the manipulation must be stopped just before it starts to rain. This plan for cooling the global surface with artificial clouds likely has not yet reached the stage of practical implementation.

A plan for cooling the global surface by emitting aerosols into the air has also been studied. The aerosols reflect or scatter rays of sunlight, preventing them from reaching the global surface.

This plan has the potential to be fairly inexpensive and practical in comparison to other cooling plans. However, effective and inexpensive aerosols are often harmful to humans. In addition, selective cooling of primarily the hottest surfaces found in low latitude regions is difficult.

A plan to cool the sea surface by pumping cold deep seawater up to the surface can also be considered. The effect of this plan is obvious, compared to the reduction of CO₂ emissions. However, an enormous amount of power and, hence, a high running cost will be necessary in addition to construction costs. Further, securing the enormous amount of clean energy resources needed is another hurdle that must be overcome for this plan to be feasible. A similar method for mitigating the intensity and damage of tropical cyclones is disclosed in U.S. Patent Application 20070257126 by David J. M. Vondracek. However, this method appears somewhat complicated and consequently expensive.

### SUMMARY OF THE INVENTION

Accordingly, it is an object of the present invention to provide a simple and inexpensive sea surface cooling system utilizing natural clean energy resources under a low running cost.

It is another object of the present invention to explain the frightening possibility of thermal runaway sufficiently, which explanation is necessary for sufficiently understanding the need and effect of the present invention.

A sea surface cooling system utilizing OTEC according to one aspect of the present invention includes means for drawing surface seawater, deep seawater pumping means for pumping deep seawater through a draw pipe, evaporator means for heating and vaporizing working fluid with a low boiling point by the drawn surface seawater, mechanical power producing means for producing mechanical power by an expansion force of the vaporized working fluid, condensation means for cooling the vaporized working fluid after the expansion by the pumped deep seawater to cause condensation, and means for circulating the condensed working fluid to the evaporator means.

The system further includes mechanical power transmission means for directly transmitting from the mechanical power producing means to the pumping means a mechanical power of variable ratio, without once converting said mechanical power into electric power. With such a configuration, the deep seawater pumping means is operated to pump deep seawater through the draw pip with the mechanical power.

Although the energy conversion efficiency of a power generation plant utilizing OTEC is low, the effect of such a plant on cooling the sea surface and the abundance of energy resources necessary for implementing the plant are obvious. The sea surface cooling has not been an original objective for OTEC, but rather an undesirable side effect for lowering energy conversion efficiency by decreasing temperature difference between surface and deep sea water. However, among other various power generation systems utilizing unlimited natural energy resources, such as solar energy, wind energy, wave energy, and tidal energy, none has a similar side effect for cooling the sea surface. If there is in fact some potential for thermal runaway to occur, the sea surface cooling utilizing OTEC will be one of the most useful means for preventing it.

### BRIEF DESCRIPTION OF THE DRAWINGS

FIG. 1 is a functional block diagram showing the construction of a sea surface cooling system according to a first embodiment of the present invention.

FIG. 2 is a functional block diagram showing the construction of the sea surface cooling system according to a second embodiment of the present invention.

FIG. 3 is a flowchart summarizing a mechanism of potential thermal runaway.

### DETAILED DESCRIPTION OF THE PREFERRED EMBODIMENT

### Newly Developed Theoretical Analyses for Global Warming Phenomena

Before describing the preferred embodiments of the present invention in detail, it should be fully understood why sea surface cooling is more effective for halting global warming than reducing CO₂ emissions, which may trigger a dangerous thermal runaway.

According to a concept developed by the present inventor, the predominant material contributing to the greenhouse effect is shifting from CO₂ to water vapor, due to the progression of global warming. Since 1964 when R. M. Goody published his paper titled Atmospheric Radiation (Oxford Univ. Press) exhibiting optical absorption characteristics of atmosphere, the fact that water vapor is a powerful greenhouse gas has been well known to those who are interested in global warming. This fact is cited in various books on meteorology.

As the sea surface temperature rises due to the progression of global warming, which has been caused or primarily led by a greenhouse effect by an increase in CO₂, the temperature of air above the sea surface also rises, causing an increase in the density of water vapor in the air above the sea surface. Accordingly, the greenhouse effect is intensified by the increased density of water vapor, causing a further rise in the temperature of the sea surface and the air above. As a result, the density of water vapor in the air above the sea increases more, further intensifying the greenhouse effect. This is so called positive feedback process of the greenhouse effect generated by water vapor.

Above some critical point, the temperature of the sea surface and, hence, the air above the sea surface begins to rise endlessly according to the positive feedback process. This endless rise in temperature occurs because the rate at which the density of water vapor in the air—and thus the intensity of its greenhouse effect—increases as a result of an increase in the temperature of the sea surface and the air above is about 7% per one degree Celsius (° C.) around the temperature of 30° C., which is five times larger than the increase rate in an amount of heat radiation from the warming sea surface.

Astrophysicist John Gribbin introduced a hypothesis suggesting that such a thermal runaway might have been responsible for transforming ancient Venus, whose surface might have been covered with oceans, into the incandescent planet we know today. However, a common theory having much support today asserts that such thermal runaway could not occur on Earth today. According to this theory, as the density of water vapor increases due to the progression of global warming, the amount of cloud above the sea also increases as a matter of course, because water vapor is an ingredient of clouds. The increased cloud cover prevents rays of sunlight from reaching and further heating the sea surface, thus cutting off the chain of the positive feedback process.

Nevertheless, the present inventor has a theory completely opposite to the common theory described above and described this concept in detail in the prior patent application titled “Solar Power Generating System Employing a Solar Battery,” which was published as U.S. Patent Application Publication No. US 20100018567 A1. According to this theory, as the sea surface temperature rises due to global warming, the amount of cloud cover above the sea decreases. The essential reason for this is a weakening of atmospheric convection, and hence a weakening of ascending current over the sea, due to the progression of global warming.

As the temperature of air above the sea rises, air expands and decreases in density. However, the decrease in the density of air by expansion is cancelled considerably by an increase in the density of water vapor in the atmosphere, because the density of atmosphere is a sum of the density of air and the density of water vapor contained in the atmosphere. Of course, the density of water vapor is much smaller than that of air but its increasing rate in response to an increase in temperature is much larger than the decline rate of air by the expansion. Therefore, the decline rate of the atmospheric density in response to an increase in temperature gradually decreases as global warming progresses.

Accordingly, a difference in the atmospheric density caused by a difference in temperature of the sea surface between different locations on the sea surface separated in a horizontal direction begins to decrease as global warming progresses, and the sea surface temperature rises everywhere almost uniformly.

As a result, a difference in atmospheric pressure at different locations on the sea surface begins to decrease as the temperature of the sea surface rises almost uniformly, because atmospheric pressure at any location is the total weight of the atmosphere above a unit area, i.e. one square centimeter.

Therefore, atmospheric convection, and hence ascending current, weakens as global warming progresses. This is because, over a wide ocean, atmospheric convection is caused by a difference in atmospheric pressure between separated locations on the sea surface.

The detailed explanation is made in the preceding patent application of the present inventor.

http://appft1.uspto.gov/netacgi/nph-Parser?Sect1=PTO1&Sect2=HITOFF&d=PG01&p=1&u=%2Fnetahtml%2FPTO%2Fsrchnum.html&r=1&f=G&1=50&s1=%2220100018567%22.PGNR.&OS=DN/20100018567&RS=DN/20100018567

However, it can be further clarified by adding the supplemental equation, ΔP/ΔL=(ΔP/ΔT) (ΔT/ΔL). Here, ΔP/ΔL is a spatial gradient of an atmospheric pressure P over a distance L along a horizontal direction on the sea surface, and is an index that indicates the intensity or activity of atmospheric convection. ΔP/ΔT is the decline rate in atmospheric pressure P in response to an increase in temperature T at any locations on the sea surface, as was described above. ΔT/ΔL is the spatial gradient of a sea surface temperature T along a horizontal direction.

As the atmospheric convection, hence the ascending current weakens, its significant function, i.e. adiabatic cooling caused by adiabatic expansion also weakens. This is because slowly ascending atmosphere has enough time to obtain heat of infrared rays radiated from hot sea surface below, through the greenhouse effect intensified by the increased amount of water vapor and expands by converting obtained heat into kinetic energy, which is necessary to expand. As a result, the function of adiabatic cooling weakens and temperature of the atmosphere rises than before at high altitude.

Further, as the ascending current weakens, there is less likelihood that the water vapor will become supersaturated and form tiny water droplets or particles of ice. This is because the atmosphere at high altitudes, which is gradually becoming warmer due to the intensified greenhouse effect of the water vapor and the weakening of the adiabatic cooling, begins to accept a larger amount of water vapor carried up from the lower altitudes, making it difficult for water vapor in the air to reach a state of supersaturation. As the number of water droplets decreases, the amount of cloud cover also decreases.

In addition, as the ascending current weakens, it also becomes more difficult for the current to carry nuclei or seeds of cloud higher in the sky by pumping them up. They are such as aerosols or tiny particles of salt or tiny droplets of sulfuric acid originated from activity of microscopic life on the sea surface, around which tiny water droplet or particles of ice cluster to produce clouds in the sky. As a result, locations of clouds shifts upward where the atmospheric temperature lowers, making them thinner because the density of water vapor and, hence, the number of water droplets decreases under the low atmospheric pressure at high altitudes. Low atmospheric pressure at high altitude also promotes evaporation of tiny water droplets, further reducing their density in the air.

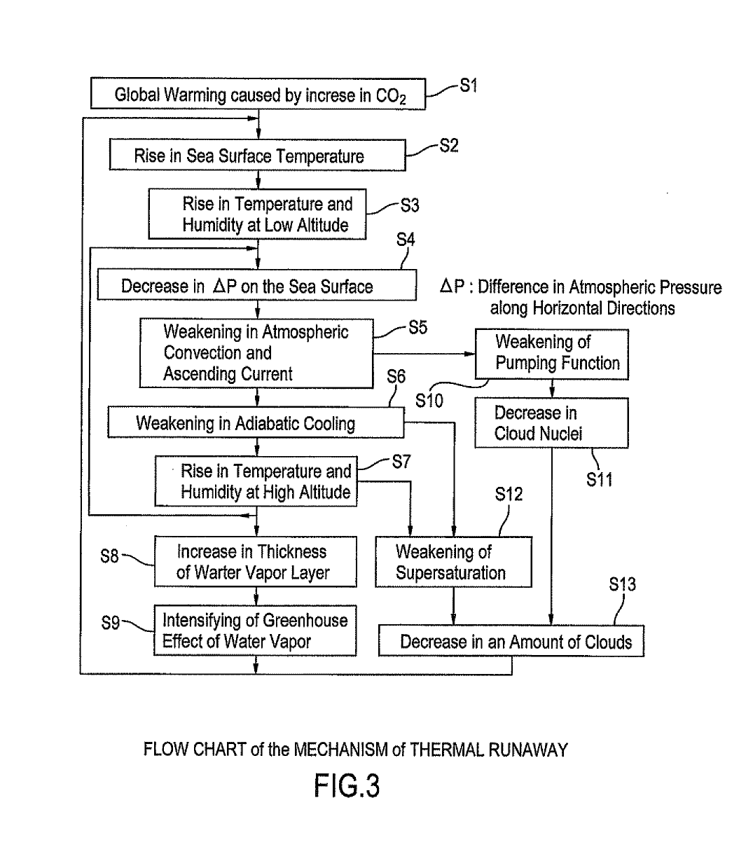

The mechanism of thermal runaway described above that is effected through a double positive feedback process in which the density of water vapor increases but the amount of cloud cover decreases is summarized in the flowchart shown in FIG. 3.

The concept described above is merely a hypothesis of the present inventor that leads to a conclusion completely contrary to the common theory. However, the possibility of this hypothesis being true has received support by two epoch-making reports on long-term observational data and analyses published after the prior patent application was filed. Further, some observational data such as that published recently by the Japan Meteorological Agency, suggests that this hypothesis may be true. This means that thermal runaway by the greenhouse effect of water vapor could occur on Earth near future. This is a very dangerous possibility, and it will be necessary to prepare countermeasures of some sort, like sea surface cooling, as soon as possible to ensure thermal runaway does not occur.

Thermal runaway will start just locally and temporally, as an incomplete form, or as a form of mini thermal runaway, at early transitional stage preceding to an ultimate final stage of it.

<Observational Data Suggesting the Occurrence of the Mini-Thermal Runaway>

An epoch-making paper titled “Observational and Model Evidence for Positive Low-Level Cloud Feedback” was published in Science 24 Jul. 2009, Vol. 325, no. 5939, pp. 460-464 by Amy C. Clement, Robert Burgman, (Rosenstiel School of Marine and Atmospheric Sciences, University of Miami) and Joel R. Norris (Scripps Institution of Oceanography, University of California, San Diego).

A commentary titled “CLIMATE CHANGE: Clouds Appear to Be Big, Bad Player in Global Warming” was published 24 Jul. 2009, by Richard A. Kerr as the “NEWS OF THE WEEK” in Science, Vol. 325, no. 5939, p. 376.

http://www.sciencemag.orgfcgi/content/summary/sci;325/5939/376

An excerpt from Kerr's commentary is cited below.

“The first reliable analysis of cloud behavior over past decades suggests—but falls short of proving—that clouds are strongly amplifying global warming. If that's true, then almost all climate models have got it wrong. On page 460, climate researchers consider the two best, long-term records of cloud behavior over a rectangle of ocean that nearly spans the subtropics between Hawaii and Mexico. In a warming episode that started around 1976, ship-based data showed that cloud cover—especially low-altitude cloud layers—decreased in the study area as ocean temperatures rose and atmospheric pressure fell. That's a positive amplifying feedback. During a cooling event in the late 1990s, both data sets recorded just the opposite changes-exactly what would happen if the same amplifying process were operating in reverse.”

In his commentary, Kerr explained that cloud cover decreased as ocean temperatures rose and atmospheric pressure fell. This can be interpreted a little more precisely as, “the atmospheric pressure above the ocean fell, but did not fall as much as it did before, because an increase in the density of water vapor weakened the drop in atmospheric pressure, weakening the ascending current and its function of adiabatic cooling.”

Kerr also included a researcher's interpretation that “the warming ocean was transferring heat to the overlying atmosphere, thinning out the low-lying clouds to let in more sunlight that further warmed the ocean.” This interpretation can be better understood with a supplemental explanation summarized in the flowchart shown in FIG. 3.

The phenomenon described above arises through two positive feedback processes of different types: one a greenhouse effect by water vapor and the other a sunshine adjusting effect by clouds. These positive feedback processes have been originally believed to countervail each other according to the widely supported common theory, but in fact strengthen each other to produce an intense double positive feedback process that accelerates global warming.

The second epochal paper, published Jul. 27, 2009 in the online edition of the American Meteorological Society's Journal of Climate, was co-authored by Scripps climate researchers D. Cayan and S. Iacobellis. The content of the paper released by Scripps News was titled “Deadly Heat Waves are Becoming More Frequent in California” and published Aug. 25, 2009 by Scripps Institution of Oceanography, the University of California, San Diego.

http://scrippsnews.ucsd.edu/Releases/?releaseID=1018

Much of the Scripps News article is cited below in its entirety, because it contains a lot of significant and detailed information to suggest happening of the mini thermal runaway and it is difficult to select much to omit.

“From mid July to early August 2006, a heat wave swept through the southwestern United States. Temperature records were broken at many locations and unusually high humidity levels for this typically arid region led to the deaths of more than 600 people, 25,000 cattle and 70,000 poultry in California alone.”

“An analysis of this extreme episode carried out by researchers at Scripps Institution of Oceanography. UC San Diego put this heat wave in the context of six decades of observed heat waves. Their results suggest that such regional extremes are becoming more and more likely as climate change trends continue.”

“The team, led by climate scientist Alexander Gershunov, examined meteorological conditions that lead to this and other recorded heat waves, when temperatures rose into the hottest one percent of historical summertime daily and nightly temperatures recorded in California and Nevada since 1948. The scientists found that heat waves in the region often fall into either of two types: the typical “daytime” events characterized by dry daytime heat and rejuvenating nighttime cooling, or the less typical “nighttime” heat waves characterized additionally by high humidity and hot muggy days and nights. Since the early 1990s, nighttime heat wave events in California, which historically had been less common, have become more prevalent, increasing in both frequency and intensity. The pinnacle of nighttime heat waves occurred in a 17-day episode during July 2006 when a persistent warm pattern was aggravated by unusually humid conditions, associated with warm ocean waters off Baja California, Mexico.

“Water vapor is the main greenhouse gas. During the night in humid environments, air doesn't cool nearly as much as it does in dry conditions,” said Gershunov. “Elevated humidity also causes heat waves to last longer. Hotter nights pre-condition hotter days and the cycle feeds on itself until the winds change. The weather pattern that traditionally causes heat waves in California is tending to bring with it more humidity, changing the character of heat waves from the dry daytime heat and cool nights typical for this region, to the muggy heat around the clock that locals are simply not accustomed to.

“The 2006 pattern of extreme muggy heat is actually part of a trend of increasing nighttime heat wave activity observed over the last six decades. This trend has accelerated since the 1980s and has become especially prevalent in this decade. The nighttime heat waves of 2001, 2003 and 2006 were each unprecedented on record when they occurred. The source of moisture that propelled the heat wave was an area of the eastern Pacific Ocean where a strong increase in sea surface temperatures has been observed and linked to global-scale trends of human-induced warming of upper oceans.

“Humidity is the key ingredient forming muggy nighttime heat waves. That same humidity usually provides some daytime relief by stoking afternoon cloud formation. The authors note that in the 2006 event, however, and to a lesser degree in the next largest 2003 event, the convection that usually triggers afternoon cooling was stifled.

“This conspicuous relative absence of convection in the presence of so much moisture led to intense daytime warming which in turn promoted more intense and extensive nighttime heat, without any observed precedent,” the researchers wrote.

“While mechanisms driving this regional anomaly are still under investigation, the researchers concluded that the trend towards more frequent and larger-scale muggy heat waves should be expected to continue in the region as climate change evolves over the next decades.”

<Heat Waves in California Might be Mini-Thermal Runaways>

The heat waves now occurring frequently in California in the summertime, as reported in the Scripps News article, can be interpreted as types of mini thermal runaways apprehended by the present inventor. These mini thermal runaways occur only locally and temporally in early transitional stages preceding its final stage. The analysis in Scripps News pointed out some principal characteristics of the heat waves that suggestive of mini thermal runaways. These characteristics include the following.

(1) Water vapor plays a major role in the greenhouse effect instead of CO₂.

(2) Weakening of atmospheric convection and reduced cloud formation

(3) Lasting for unpredictable periods that are often fairly long, as was not the case before

Characteristic (2) in particular coincides with the long-term observational data reported by research team at the University of Miami and University of California. This feature further coincides with an analysis of long-term observational data conducted by a research team at the University of Alabama in Huntsville and published in Geophysical Research Letters, Vol. 34, 2007 under the title “Cloud and radiation budget changes associated with tropical intraseasonal oscillations” (Roy W. Spencer, et al.).

The research team analyzed a large amount of observational data collected over six years with four observation devices mounted on three NASA and NOAA satellites. The team reached a conclusion that the amount of cirrus in tropical regions decreases as atmospheric temperature rises. Here, cirrus is a cloud formed at high altitudes around 10 kilo meters, in contrast to maritime cumulus that are formed at low altitude ranging from few hundreds to few kilometers above sea level.

The research team at the University of Alabama has a view that the decrease in cirrus promotes heat radiation from the global surface for cooling the surface in tropical regions. The present inventor holds the opposite view that the decrease in cirrus rather promotes warming of the global surface by allowing sunlight to pass through and heat the surface, just like in the case of low-level cumulus, as Kerr notes in his comments. The cooling effect caused by the decreased amount of cirrus will be small, because most infrared rays radiated from the global surface will be absorbed by water vapor or CO₂ before reaching the cirrus at high altitudes, preventing through reflection or absorption the infrared rays from leaving the Earth.

As far as the change in the amount of clouds, setting its effect aside, the conclusions reached by researchers at the University of Miami, University of California, San Diego, and the University of Alabama, Huntsville coincide in that the amount of clouds decreases as the sea surface temperature increases.

<Difference Between Performances of Water Vapor and Water Droplets>

Water vapor takes an intermediate state between tiny water droplets (liquid) and molecules (gas). Inside a water molecule, a positional deviation of electric charge formed due to unsymmetric locations of atoms inside causes each molecule to form a tiny electric dipole. The sides of water molecules having opposite electric polarity pull each other by a Coulomb force to form a cluster of water molecules. The size of the cluster increases to have a characteristic of liquid at a low temperature, and decreases gradually as the temperature rises. Superheated water vapor of about 500° C. for driving a steam turbine will exhibit a faint characteristic of gas. Large specific heat observed in the heating process suggests that such a model is correct. Heat supplied externally would have been consumed as energy necessary to separate the molecules from each other. In the sky of low temperature energy may be supplied not by heat but by radiation energy in sunlight near the boundary of visible rays and infrared rays. Some of these rays may be of wavelengths of 0.9, 1.0, 1.4, 1.7, and 2.5 and 6.0 microns, which can be seen in R. M. Goody's atmospheric optical absorption diagram described above.

Water vapor has two fundamental functions necessary to act as a greenhouse gas like CO₂. One is an optical function for selectively absorbing primarily infrared rays. The other is a kinetic function for transmitting heat obtained by optical absorption to the air through frequent and almost elastic collisions with molecules of nitrogen and oxygen, heating the air directly and almost instantaneously. This is because densities of molecules are high enough even at high altitude of low atmospheric pressure. Water droplets in the sky also have an optical function for absorbing not only infrared rays but also rays of any wavelengths ranging from far infrared rays to ultraviolet rays like water. However the droplets do not have the kinetic function described above at all.

From this perspective, the behaviors of water molecules and water droplets can be strictly distinguished. Therefore, the new type of heat waves observed and analyzed by researchers at Scripps Institute of Oceanography can be distinguished strictly from the conventional type. In the new type of heat waves, infrared rays are absorbed by water vapor or droplets day and night, but transmission of the absorbed heat, i.e. heating of the air through collisions of molecules, occurs mainly in the daytime under strong sunlight facilitated by the reduced amount of clouds. The strong sunlight caused by the reduced cloud covers plays significant role not only for heating the sea surface but also for superheating water vapor in the sky to produce a large amount of water molecules for heating air directly through the kinetic function.

The kinetic function of water molecule is also indispensable in the mechanism for producing hurricanes. Water molecules in the sky absorb infrared rays emitted from the sea surface or condensing water vapor in the sky and transmit the absorbed heat through frequent and almost elastic collisions with molecules of nitrogen and oxygen to heat air and intensify kinetic energy causing a macroscopic helical motion of the air. Therefore, the process of developing hurricanes provides the most popular evidence for proving the strong greenhouse effect of water vapor. Landed hurricanes weaken by having their supply of water vapor from the sea surface shut off. Mini thermal runaways also weaken as they leave the sea for the same reason, as demonstrated in the cases of heat waves in California.

<Significance of the Sea as a Stage for Mini Thermal Runaways>

It may be thought that the mini thermal runaways occurring in California are simply temporal, natural disasters caused by global warming but do not accelerate the global warming like hurricanes. However, the mini thermal runaways store heat of sunlight in the sea, while hurricanes dissipate the stored heat. Thus, the mini thermal runaways accelerate the global warming, although they are so far so fragile that have a short lifetime, being easily blown out by the change of winds, as was pointed out in the Scripps News article.

The mini thermal runaways are caused by intense but shortly sustainable and frequently occurring greenhouse effect by an increased amount of water vapor. The product of intensity, duration and frequency of the greenhouse effect indicates a net heat gain in the global surface. By dividing this by a macroscopic thermal capacity of the global surface, which can be evaluated to be equal to that of global sea surface layer of modified thickness of 700 meters, the rise in temperature at the global surface can be obtained, which is of great interest for analyzing global warming.

Oceans—and particularly their surface layers—play an important role in promoting global warming through mini thermal runaways, as was the case in the heat waves in California. There are some reasons for this. One is that they play an indispensable role in sustaining the positive feedback process by providing an almost unlimited supply of water vapor to the overlying atmosphere. The second is that they have a distinct function for accumulating large amounts of heat. The third is that they cover an area of the global surface three times larger than land, especially in the hottest tropical regions.

Rocks, sand, and mud covering the surfaces of dry land have a considerably small thermal conductivity and heat capacity than seawater. Therefore, the temperature of the dry land surface rises easily under strong daytime sunlight, often exceeds as high as 50° C. in low land desert regions. Accordingly, the land radiates a large amount of heat in order that only a small amount of heat is accumulated. In contrast, since seawater has quite large thermal conductivity and heat capacity than land, the temperature of the sea surface does not rise as easily and, hence, accumulates a large amount of absorbed heat. Accordingly, the sea plays an important role in promoting global warming through frequent mini thermal runaways. That is to say, the temperature of the sea surface will begin to rise more rapidly than before through heat accumulation caused by the frequent repetition of mini thermal runaways.

The fact that the first report on heat waves, which can be assumed to be mini thermal runaways, was issued in California or even in the higher lands of Nevada, suggests that abnormally high temperatures, which can be also called heat waves or mini thermal runaways, may be occurring all over the world, especially in hot maritime regions of low latitude where the sea surface temperature is always kept as high as nearly 30° C. This will be examined below using observational data analyzed by the Japan Meteorological Agency (JMA).

<JMA's Schematic View of the World's Abnormal Weather>

JMA is analyzing abnormal or extreme weather happening all over the world on the basis of observational data reported from about 2000 observatories or weather stations in various member countries of the World Meteorological Organization covering nearly the entire world. The abnormal weather is divided into four categories, namely, abnormally hot, abnormally cold, abnormally excess precipitation and abnormally too little precipitation. The determination of abnormal or not abnormal in each category is made according to a magnitude of anomaly, which is a deviation from a normal value, i.e. an average value over past thirty years, in temperature or precipitation. JMA draws global schematic diagrams manually, indicating the regions in which abnormal weather occurs by delineating the regions with contour lines and filling them with a different color for each category, i.e., Hot; Red, Cold; Blue, Excess precipitation; Green, Too little precipitation; Yellow. The drawings are made for various time periods—one week, one month, one season (three months), and one year—and are periodically published together with expert analyses on the causes of abnormal weather and/or examples of abnormal situations.

http://www.data.jma.go.jp/gmd/cpd/monitor/monthly/

Recent events of abnormally hot weather taken from JMA's monthly data for 2008 and 2009 will be examined basing on some common characteristics with the heat waves in California as described in the Scripps News article; namely, a location in or adjacent to a maritime region, a decrease in the amount of cloud cover, a weakening of atmospheric convection or convective activity, and abnormally hot weather in high lands, for example.

<1st Characteristic: Abnormally Hot Weather in a Low Latitude Maritime Region>

The first remarkable characteristic is an increase in the number of regions located in low latitude zones and including a maritime region in which abnormally hot weather occurred. To quantify this characteristic, the regions are limited to those with more than 40% of their area positioned in a low latitude zone below 30 degrees and more than 10% of their area in a maritime region. The number of such regions was 14 in 2008, but increased to 37 in 2009, an increase of nearly 3 times in just one year.

The reason that the portion of such regions included in a maritime zone is as small as 10% can be considered as follows. The rise in sea surface temperature is considerably smaller than rise in atmospheric temperature on the land due to larger thermal conductivity and heat capacity of the sea water, as described above. This suggests that mini thermal runaways happening above the sea cannot be detected by means of observing abnormal rise in temperature, unless it spreads over the remote islands or costal area as was the case in heat waves in California.

<2nd Characteristic: Decrease in Amount of Clouds>

The second characteristic is a decrease in the amount of clouds. In the JMA's comments, the phrase or term “a longer duration of sunshine than normal” is often used to explain the cause of abnormally hot weather. This phrase has the same meaning as “a decrease in the amount of cloud than normal.” This is the most significant characteristic for explaining the occurrence of mini thermal runaways, as described above. This characteristic is being proved by long-term observational data obtained by the University of Alabama, University of Miami, and University of California, San Diego, as described above.

<3rd Characteristic: High Temperatures and Too Little Precipitation>

The third characteristic is an increase in the number of regions where abnormally too little precipitation happened at the same time among the regions exhibiting the 1st characteristic described above. The number of such regions was only one in 2008, and increased to seven in 2009, although two regions of the different categories are overlapping only partially in most cases.

In the expert's comments explaining the cause of this abnormality, the phrase “convective activity was weaker than normal and sunshine period prolonged” often appears. For example, a wide region that covers all of Mexico, the Gulf of Mexico, the Caribbean Sea, and the northern part of South America (7) exhibited abnormally high temperatures and abnormally low precipitation in August 2009. The exact same phrase mentioned above was used in the comments to explain the cause of this abnormality. Here, “(7)” is a number JMA assigns to each area with abnormal monthly weather to distinguish areas from each other in each month.

<4th Characteristic: Extremeness of High Temperatures>

The forth characteristic is extremeness of high temperatures. For example, a region of Iran that includes the Persian Gulf exhibited abnormally high temperatures in July 2009 (5). According to the comments, the monthly average temperature was 36.5° C. in Teheran (altitude of 1400 meters), which is higher than normal by as much as 5.8° C.

Another region having abnormally high temperatures in September 2009 covers a vast region from the southern part of India to the central part of Africa (5). According to the comments, the temperature in Dalbandin, located in southern Pakistan at a high altitude (843 meters), reached a daily highest of 43° C. on consecutive four days (21-24), which is higher by 7° C. than the normal daily highest. In Zahedan in the southeastern part of Iran (5), the monthly average temperature reached 26.3° C., which is higher by 4.1° C. than normal. This extremeness of high temperatures progressed further in the next year. For example, in Dalbandin, southern Pakistan, the average temperature recorded during a three-month span from March to May 2010 was 28.8° C., higher by 4.9° C. than normal. This means that the annual average temperature for this region will increase by at least 1.2° C., even if the remaining nine months conform to the normal.

<5th Characteristic: Warming in High Land>

The fifth characteristic is that the regions of abnormally high temperature spread even to high lands that are separated from a maritime zone by a high mountain range. This characteristic applies to the case of heat waves that occurred in Nevada and California and is one of the most significant characteristics because the mini thermal runaway causes high temperatures in high-altitude through weakening of the atmospheric convection and especially the ascending current above the sea. The comments given on abnormally high temperature areas include a lot of towns located at high altitudes and known as summer resorts. Some examples are given below with their elevation in units of meters written in parentheses after the town name.

Examples of towns located in high land regions neighboring the Gulf of Mexico or Caribbean Sea include Monterrey (1500), Mérida (1640), Caracas (960), Ibagué (1300), Tucumán (430), and Córdoba (450). Examples of towns located on the high land regions of inland China, the Tibetan Plateau, or the Deccan Plateau include Taiyuan (800), Yinchuan (1100), Techen (3400), and Lhasa (3700).

Executive Director Achim Steiner of the United Nations Environment Programme (UNEP) announced in December 2009 that average temperature in Hindukush-Himalayan region rose 0.6° C. in this decade that is nearly ten times higher than the worldwide average of 0.74° C. over the past century.

http://www.un.org/apps/news/story.asp?NewsID=33228&Cr=drought&CH=

To summarize, some of the characteristics described above illustrate that mini thermal runaways have already started happening, primarily in low latitude regions, accelerating global warming in the sea and maritime regions as a result.

Referring to the JMA's annual global map showing regions in which abnormal weather patterns have occurred in each of the three successive years from 2007 to 2009, regions with abnormally hot weather have shifted from high latitude zones above 30 degrees to low latitude zones below 30 degrees. At the same time, regions having abnormally cold weather have shifted in the opposite direction.

http://www.data.jma.go.jp/gmd/cpd/monitor/annual/

Excess heat produced by mini thermal runaways may have begun to be accumulated recently in the sea rather than being transported to higher latitude region as in the past, due to a weakening of atmospheric convection over the oceans. Global warming may have reached a new stage in which the increasing rate in average global temperature appears to decelerate for a while.

This is because the expanse of sea is larger in low latitude tropical regions and a rise in temperature on the sea is smaller compared to that on land in the high latitude regions, while a large amount of heat is accumulated in the sea, as was explained above. This phenomenon is pulling attention recently as a rapid increase in Ocean Heat Content, that indicates an amount of heat accumulated in the sea surface layer of thickness of 700 meters.

A study grope led by University of Colorado at Boulder announced Jul. 13, 2010 that a huge Indo-Pacific warm pool spreading over tropical oceans from the east coast of Africa to the international date line has heated by about 0.5° C. in recent 50 years.

http://www.colorado.edu/news/r/4db6c47a28ba81f1853061bfd4260128.html

The weakening of heat transportation function from low latitude hot regions to high latitude cold regions may even cause a decrease in temperature in high latitude region, which may induce misunderstanding as if the global warming has weakened or ceased.

In regions of middle latitude in northern hemisphere where most developed countries are located, abnormally hot weather and abnormally cold weather will be repeated frequently, depending on the direction of the winds that transport hot air from warming hot regions at low latitudes or cold air from cooling cold regions at high latitudes.

If the global warming develops at the same time everywhere, or homogeneously, the huge amount of Antarctic ice, which is estimated to be about 22 quadrillion tons, will consume an enormous amount of latent heat when melting, slowing down the development of the global warming greatly, at a expense of a rise in the global sea level. Therefore, the weakening of the heat transportation from the tropical regions to high latitude regions, especially to the Antarctic region, is a very dangerous phenomenon, because the cooling effect of melting ice cannot work.

<Cost of Reducing CO₂ Emissions>

So far, the global warming has been developed slowly by weak greenhouse effect caused primarily by an increase in CO₂. This is because the density of CO₂ has already reached to a sufficiently high level fairly long time ago. In other word, an absorption rate of the infrared rays by CO₂ has been already saturated. A mechanism of a slow development in the global warming after the absorption rate has been saturated can be explained by utilizing a method similar to a ray tracing method. However, it may be somewhat complicated and is omitted here. Any way, due to the saturation, an amount of heat of infrared rays to be absorbed by CO₂ will increase only slightly, even if CO₂ concentration is increased considerably due to artificial emission. John Gribbin pointed out this fact in his book more than twenty years ago, He explained that even doubling the CO₂ concentration from 300 to 600 ppm, only increases the amount of heat trapped by the greenhouse effect by an average of four watts per square meter. This is quite small and is reasonable value. This means that even if the density of CO₂ is reduced considerably, at a expense of huge cost, it will not be effective so much to stop the ongoing global warming. He also pointed out that the water vapor feedback effect was amplifying the CO₂ greenhouse effect by factor of three.

Once the mini thermal runaways have started to happen, it may no longer be possible to prevent the progression of the global warming by only reducing artificial CO₂ emissions. Even if the excess amount of CO₂ is reduced considerably, the global warming triggered by weak CO₂ greenhouse effect will be accelerated through the increase in the amplification factor caused by a rise in the sea surface temperature due to intense double positive feedback process explained above. However, it will still make sense to compare a cost for reducing CO₂ and the sea surface cooling, because the inventor's concept has not yet been proven.

The amount of CO₂ emitted artificially in the world in 2005 and 2006, respectively, is estimated to be about 27 Giga tons (based on the IEA World Energy Outlook and other sources). This denotes the weight of the CO₂, which is larger by about 3.7 times than that of the carbon atom alone. The annual increasing rate of CO₂ is estimated to be 2 ppm in atmospheric concentration and, hence, 10 giga tons (G tons) in total weight, because the total weight of the Earth's atmosphere is 5.1 quadrillion tons. In summary, 27 G tons of CO₂ is emitted artificially in a year. Of this amount, 10 G tons is accumulated in the air, thus the remainder, i.e. 17 G tons, is absorbed in the oceans and is finally fixed as a component of shales on the seabed through activity of planktons. Forests do not have such ability for fixing absorbed CO₂ for long time.

Excess CO₂, which has been accumulated in the atmosphere since the Industrial revolution started is estimated to be 100 ppm in atmospheric concentration, hence 510 G tons in weight. Setting aside reducing the huge amount of excess CO₂, it will be at least necessary to stop its increase to prevent the progress of the global warming, assuming that the common concept is correct. To this end, it is essential to reduce annual emissions in the world from 27 G tons to the 17 G tons that can be absorbed in the ocean in a year. This equates to a reduction of about 40 percent in annual emissions.

Japan announced a CO₂ reduction plan of 25% at the Climate Conference held in Copenhagen on December 2009. This reduction plan has the effect of reducing only 1% of the total emissions in the world, because the amount of emissions in Japan currently accounts for about 4% of global emissions. The Japan National Institute for Environmental Studies announced on March 2010 that an additional investment of 100 trillion yens would be necessary to implement the reduction plan. Therefore, the additional cost necessary for reducing emissions by 40% worldwide is roughly estimated to be about 4 quadrillion yens, or 44 trillion dollars. The cost for implementing the sea surface cooling according to the present invention will be compared with this cost, latter.

The intensity of greenhouse effect is evaluated by a product of a greenhouse effect by CO₂ and the amplification factor by water vapor, as described above. According to the inventor's concept, the amplification factor itself increases as amount of water vapor in the air increases due to a rise in the sea surface temperature. Therefore, it is far more effective and important to decrease the amplification factor of water vapor by lowering the sea surface temperature artificially than decreasing an amount of artificial emission of CO₂. It may already be to late when the details of a phenomenon as unprecedented and extraordinary as the permanent and global scale thermal runaway become clear. From the viewpoint of security, it is desirable to prepare as soon as possible.

The explanation has been protracted somewhat because it is essential to understand the dangerous situation for practicing sea surface cooling according to the present invention regardless of the enormous cost.

Some power generating systems utilizing OTEC are already in operation. One of these is a land-based OTEC facility on the Kona coast of Hawaii that belongs to the United States Department of Energy and serves as a power plant for the U.S. Navy operating on the Indian Ocean, etc. There is a plan to build a 10-Megawatt commercial power plant in Guam. The activities of the Institute of Ocean Energy of Saga University in Japan on OTEC are also well known. The Uehara cycle is known for its achievement of remarkably improving energy conversion efficiency by utilizing a working fluid comprising a mixture of ammonia and water. Research and development on OTEC systems is so advanced that a sea surface cooling plan could be implemented immediately because low conversion efficiency is not a fundamental disadvantage for such cooling systems.

### First Embodiment

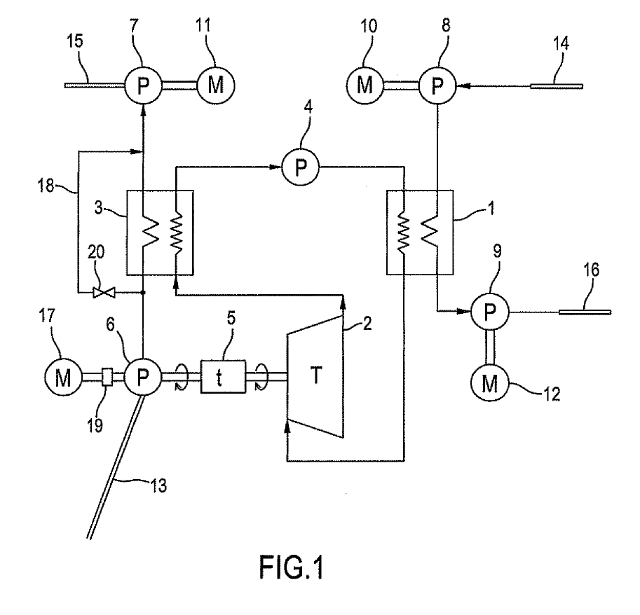

FIG. 1 is a functional block diagram showing a construction of the sea surface cooling system according to the first embodiment of the present invention. In the figure, reference number 1 denotes an evaporator, 2 a turbine, 3 a condenser, 4 a circulation pump, 5 a transmission for rotary power, 6 a deep seawater draw pump, 7 and 9 drain pumps, 8 a surface seawater draw pump, 10, 11, and 12 electric motors, 13 a deep seawater draw pipe, 14 a surface seawater draw pipe, 15 a deep seawater drainpipe, 16 a surface seawater drainpipe, 17 a starter motor, 18 a bypass pipe, 19 a coupling/decoupling unit, and 20 a stop valve.

Although many of the elements are shown in a singular form, they may actually consist of a plurality of the same elements of a smaller size that are connected in parallel or in cascade and work in synchronization with each other.

The sea surface cooling system shown in FIG. 1 is a modification of a typical closed-cycle OTEC power plant utilizing a working fluid comprising a mixture of ammonia and water. The sea surface cooling system is constructed on a coastline or a floating platform on the sea.

In this embodiment, the draw pipe 13 is designed to extend downward to a depth of 150 meters. The draw pipe 13 is designed to conduct deep seawater at a maximum flow rate of 30 tons per second in a steady state, with a head loss of about 150 meters. The power required to draw deep seawater through the draw pipe 13 is 88 MW (30×10³ Kg/s×9.8 m/s²×3×10² m=9×9.8×10⁶ Kg m²/s² 1/s). Here, M stands for Mega (million). In a steady state after the flow has become stable, all the drawing power of pump 6 is supplied from turbine 2 through transmission 5.

Operations of the system in the steady state will be described first. Hot surface seawater is drawn into the system through pipe 14 and pump 8 and conducted to a heat supply pipe of a heat exchange unit inside evaporator 1. The working fluid is heated by the hot surface seawater until it evaporates, and the resultant vapor is then supplied to turbine 2 for rotating the same with its expansion force. The expanded working fluid is subsequently conducted to a heat supply pipe in a heat exchange unit inside condenser 3 and is cooled by the deep seawater. The cooled and condensed working fluid is then supplied back to evaporator 1 by circulation pump 4.

The surface seawater used for heating the working fluid in evaporator 1 is drained into the nearby sea at the sea surface through drain pump 9 and drainpipe 16. The cold deep seawater drawn through pipe 13 by pump 6 is subsequently drawn along two separate paths by pump 7. One path leads to a cooling pipe in a heat exchange unit within condenser 3, while the other path leads to drain pump 7 through bypass pipe 18 and stop valve 20. The latter is kept open in the steady state.

Motors 17, 11, 10, and 12 are supplied power for driving respective pumps 6, 7, 8 and 9 from a commercial power supply located outside the system or from an appropriate power supply subsystem (not shown in FIG. 1) built into the system.

A rotary axis of turbine 2 is mechanically coupled to a rotary axis of draw pump 6 through transmission 5. Transmission 5 transmits all the rotary power produced by turbine 2 to draw pump 6 unchanged, i.e. without converting the rotary power to electric power. Starter motor 17 can be coupled selectively to draw pump 5 through coupling/decoupling unit 19.

In the steady state, draw pump 6 is decoupled from starter motor 17 and, hence, is driven only by turbine 2. The waste deep seawater drained from condenser 3 together with the deep seawater drawn through bypass pipe 18 and stop valve 20 is supplied to the nearby sea surface through pump 7 and pipe 15 for cooling the sea surface. Drain pump 7 also works as a draw pump on the overall draw path in cooperation with draw pump 6. To stabilize the flow of deep seawater, the pumping power of pump 7 is controlled by regulating the mechanical output power of motor 11.

Next, operations of the system upon start-up will be described. The system is started by driving pumps 6-9 by driving the corresponding motors. When the system is started up, stop valve 20 is closed and all the deep seawater drawn through pipe 13 is supplied to condenser 3. The cooling effect in condenser 3 just after the start of the system is insufficient, because the flow of deep seawater is considerably small compared to its maximum value in the steady state and because the cooling effect in condenser 3 has a thermal delay time. However, a small increase in the flow and, hence, a small increase in the cooling effect of condenser 3 increases the efficiency of energy conversion in the system slightly. This produces a slight increase in output power from turbine 2, which slightly increases the driving power of draw pump 6. The increase in driving power in turn produces a small increase in the flow of deep seawater. This is a typical positive feedback process in which an increase in the flow of deep seawater leads to a further increase in flow through an increase in the cooling effect in condenser 3 and, therefore, an increase in the power output from turbine 2.

When the flow has reached a considerably large amount, such as a few tons per second, stop valve 20 is gradually opened. When the flow has reached the maximum value of 30 tons per second, two thirds of it, i.e., 20 tons per second, is supplied to condenser 3 while the remaining 10 tons per second is simply drained onto the nearby sea surface through bypass pipe 18 and drain pump 7. The excess flow of seawater is drained because cold seawater supplied at a rate of 20 tons per second is sufficient for condenser 3 to realize its maximum cooling function and the cooling capacity of condenser 3 does not continue to increase even if the flow is increased further.

Transmission 5 is controlled to increase the rate at which rotary power is transmitted from turbine 2 to draw pump 6 step-by-step in synchronization with the controlled flow of deep seawater. For this purpose, transmission 5 comprises various appropriate mechanical elements, such as gear boxes for changing a revolution rate, a flexible joint for transmitting rotary power by assimilating displacement or angular difference between the rotary axes, and a coupling/decoupling unit for selectively transmitting rotary power. In synchronization with increases in the transmission rate of rotary power, the driving power of starter motor 17 is decreased gradually and ultimately decoupled from draw pump 6.

Once the system enters the final steady state, the flow stabilizes because the cooling function cannot respond to fluctuations in flow due to the delay in its thermal characteristics. Therefore, the mechanical output power from turbine 2 remains constant. This is because with a constant mechanical output power from turbine 2, a slight increase in flow due to fluctuations causes a slight increase in head loss in draw pipe 13, which in turn results in a slight decrease in flow, and vice versa. In this steady state, the mechanical power output from turbine 2 reaches the maximum value of 88 MW for drawing deep seawater from a depth of 150 meters at a rate of 30 tons per second, with a head loss of 150 meters.

In this embodiment, the system effectively avoids a conversion loss that inevitably occurs in intermediate energy conversion processes by a generator and a motor. As a result, a total conversion loss of a few tens of percent, i.e. a few tens of MW, can be saved over common schemes that employ a generator and a motor for intermediate power conversion. In addition to this advantage, the system of this embodiment eliminates the cost for installing an expensive high power generator and a motor, reducing the overall construction costs of the system considerably.

Generally in an OTEC system, energy conversion efficiency can be improved by using colder seawater drawn from a lower depth. However, the amount of power required for drawing up seawater increases as the depth increases. From this point of view, it is desirable to utilize a special layer in the ocean called a thermocline, where the seawater temperature drops quickly as its depth increases. The thickness of the thermocline varies largely depending on its location. For example, the thermocline is some tens of meters thick in the eastern Pacific Ocean and 150-200 meters thick in the western Pacific Ocean. Its worldwide average is roughly estimated to be 150 meters.

Assume there is an imaginary column of seawater having a cross section of one square meter that extends vertically through a thermocline 150 meters thick. Further assume that 10 tons of deep seawater at 18° C. is drawn from a depth of 150 meters and mixed with 50 tons of surface seawater at 28° C. The thickness of each layer is 10 meters and 50 meters, respectively, because both are assumed to be inside the imaginary column.

When mixed with the deep seawater, the temperature of the surface seawater drops by 1.7° C. to 26.3° C. The mixed surface seawater and deep seawater are further diffused and mixed in horizontal and vertical directions by sea currents and differences in the densities of cool and warm seawater. The work necessary for drawing 10 tons of deep seawater from a depth of 150 meters with a head loss of 150 meters is about 30,000 KJ, which is about 8.3 KWH (0.83 KWH/ton).

The total surface area of the world's oceans is 360 trillion square meters. About a half of this, primarily located outside the tropical region, is not targeted for the sea surface cooling operation because the temperature of the sea surface outside the tropical region will not rise as much as global warming advances due to a decrease in heat being transported from the tropical region. In this case, the total amount of deep seawater to be drawn worldwide is estimated to be 1.8 quadrillion tons. The power required for the global cooling operation is 1.5 quadrillion KWH.

The sea surface cooling system of the present embodiment draws 28.4 G tons of deep seawater by drawing 30 tons per second for 30 years. Thus, 63,000 systems of the same scale as that described in the present embodiment would be necessary to draw 1.8 quadrillion tons of deep seawater worldwide in 30 years. Further, a drawing power of 50 trillion KWH would be required annually to implement the global cooling operation in 30 years. This is almost equivalent to the total amount of mechanical power roughly estimated to have been able to generate worldwide in 2005. Based on this estimation, it is impossible to secure the necessary power through conventional types of high-efficiency power production, such as conventional steam power generation, atomic power generation, or the various types of green power generation utilizing natural energy resources. There is no alternative but to rely on OTEC power generation, which is an almost unlimited power source as is known to be producing enormous power for driving various huge sea currents.

The sea surface cooling system of the present invention will be constructed to prevent development of the global warming, which may induce the dangerous final thermal runaway. However, when it becomes clear that the potential for thermal runaway has been eliminated or sufficiently reduced by implementing the sea surface cooling operation, the systems can be converted into commercial power plants for producing and maximizing the net supply of power.

For this purpose, the core of the system can be restructured for producing net power by modifying or adding equipment as needed, while keeping intact the main structure of the system, including large-scale facilities such as the draw pipe system and buildings housing the core of the system. For example, a generator for producing net power can be added to the other side of the rotary axis of turbine 2.

The output power from turbine 2 is divided in half, with one half being supplied to pump 6 and the other half to the newly added generator. As a result, the mechanical power for driving draw pump 6 is reduced, causing a considerable reduction in the flow of deep seawater. Thus, the effect of cooling the sea surface will be reduced to a minimum level at least necessary to produce the electric power. This is because the sea surface cooling effect is originally an undesirable side effect for OTEC power generation to reduce conversion efficiency and hence net output power, by decreasing temperature difference between hot surface seawater and cold deep seawater.

For this purpose, the flow of deep seawater is reduced to two thirds, i.e. 20 tons per second, by closing stop valve 20 and supplying the entire flow to condenser 3. With the reduced flow, head loss in the flow path will be reduced to about 70 meters. Half of the total mechanical power output from turbine 2, i.e. 44 MW is used to drive pump 6, and the remaining 44 MW is used to drive the newly installed generator (not shown in FIG. 1). Assuming that the driving power of 44 MW is converted into electric power at a conversion efficiency of 90 percent, 40 MW of electric power is produced in the reformed power plant of the embodiment. Starter motor 17 can also be removed by using the newly installed generator for starting the system.

Additionally, various improvements can be made to evaporator 1 and condenser 3 forming the core of the system through modifications or the addition of new equipment.

<Design of Draw Pipe 13>

To reduce construction and operation costs, the design, manufacture, and laying of the draw pipe 13 for drawing a large amount of deep seawater is important. When describing the various sizes and performances of draw pipe 13, the following symbols will be used below: inner diameter d (meters), length L (meters), flow of deep seawater Q (tons per second), and pipe frictional factor λ. Head loss h arising inside draw pipe 13 is given as 0.083λ(Q²/d⁵) L meters according to Bernoulli's theorem.

Although the deep seawater is drawn up only 150 meters vertically, the length L of the draw pipe may vary considerably depending on the location in which the draw pipe is laid, such as whether the pipe can be laid on a wide shallow continental shelf. Assuming the average length L to be 30 kilometers, the inner wall to be smooth, and the head loss to be 150 meters, then the inner diameter d must be set to at least 2.6 meters for drawing deep seawater at 30 tons per second. While this size of a draw pipe gives the impression that construction costs for the draw pipe system will be considerably large, there are numerous advantages of such a draw pipe system for reducing construction costs considerably.

A first advantage is that water pressure applied to the pipe wall from both outside and inside are always balanced and cancel each other at any depth in the sea, provided that the pipe has some flexibility. Therefore, the pipe wall generally needs only be strong enough to be able to resist forces that will be applied during construction. Accordingly, the pipe can be fabricated of some of the popular plastics or polymer materials, such as polyvinyl chloride (PVC), that are inexpensive, seawater-proof, and light, though not so strong. In addition, the thickness of the pipe wall can be reduced significantly, thereby considerably reducing the costs of fabrication and installation.

A second advantage is that, for the pipe formed by connecting short pipes together, small leakages at the connected portions of the pipe can be allowable, because such leakages will result in only a slight rise in temperature of the drawn deep seawater. As a result, precision in the mechanism and operation for connecting the short pipes is not critical, thereby reducing costs and simplifying the process.

A third advantage is that the environment on the seafloor is far less severe than that on land or at the sea surface, because there are no storms, strong waves, or sea currents on the seafloor. Accordingly, it is possible to employ a very simple laying structure and the laying operation as easy as just sinking the pipe in the sea and putting it on the seafloor. There is no need to bury the pipe under the seafloor or even fix it on the seafloor, except in rare cases when the pipe is bent or hanged in the sea water over a groove of seafloor and incurs a centrifugal force from the drawn water inside or a pulling force from its own weight. Even in such cases, attaching rocks or concrete blocks to the pipe as simple pendulums is sufficient for roughly anchoring the pipe on the seafloor.

A fourth advantage is that the weight of the pipe itself is significantly reduced by the buoyant force of the seawater. The density of polymer materials such as PVC is as small as 1.4 tons per cubic meter, and is further reduced to 0.4 tons per cubic meter in the seawater. As a result, the laying operation becomes very easy, and any pulling force applied by its own weight at the hanging structure in the seawater becomes small.

A fifth advantage is that the draw pipe can be laid without having to first conduct troublesome and time-consuming negotiations, since there is neither landowner nor dweller on the seafloor, the possible exception being negotiations with unions of fishermen. Further, even in the event of an accident involving large-scale leakage from the pipe, there will be no damage to the environment or wildlife, as occurs in accidents such as oil spills. As a result, it is possible to set lower safety standards, reducing construction costs considerably.

Further, draw pipes as long as a few hundred meters can be carried to the laying site in the sea because the sea surface is not as crowded as land. By using longer pipes, the number of connections required to form the overall pipeline can be reduced considerably, thereby reducing the costs for fabrication and laying, including the connection of short pipes.

<Method of Manufacturing and Laying the Draw Pipe>

By utilizing all the advantages described above, construction costs of the draw pipe 13 can be reduced considerably. An example of a method for manufacturing and installing a long draw pipe will be described below.

An endless thin plate formed of PVC at a thickness of 25 millimeters is produced from an injection-molding machine. An endless pipe with an inner diameter of 2.6 meters and a wall thickness of 25 millimeters is formed by wrapping both lateral sides of the endless plate around the circular surface of a cylindrical mold, and the side edges are joined by fusion splicing. The endless pipe is cut at lengths of 300 meters. A plug and a socket for forming a connector are attached to each respective longitudinal end to form a unit pipe of 300 meters long.

One example of a connector is so called a one-touch type connector, which is commonly used for fastening various belts. Plastic beams formed inside the socket deform elastically in a radial direction when a pushing force is applied by a tip-portion of the inserted plug, allowing the plug to be inserted into the socket. When the tip end of the plug nearly contacts a stopper formed on the inner surface of the socket, nails formed on the end portion of the elastic beam drop into a groove formed in the outer surface of the inserted plug with a clicking sound. This insertion inhibits the plug from moving further forward or backward, completing the connection.

The weight of a unit pipe of 300 meters long is about 86 tons. The air pressure inside the unit pipe is maintained slightly higher than the external air pressure to prevent the pipe from buckling by its own weight as it is still hot and soft before it is immersed and stored in the seawater. Once the pipe is in the seawater, the weight of its wall is reduced to one third. Further, wall is supported by seawater filling inside the pipe so that the wall does not buckle at this time.

The stored unit pipes are towed to the laying site while suspended in the seawater by attached floats. The rear end portion of new unit pipe is connected on the sea surface to a tip portion of a long draw pipe already connected and a rear portion of which is already sunk in the sea and laid on the sea floor. The connecting operation is performed on a small deck attached to the sidewall of an operation ship at the sea surface using cranes installed on the deck of the ship. The rear portion of newly connected unit pipe is allowed to sink slowly by its own weight leaving its tip portion on the sea surface, with the tip portion of already connected long draw pipeline. If it is necessary, weights such as rocks or concrete blocks are attached for roughly fixing the pipe on the seafloor. Thus, a long draw pipeline is extended offshore each time a new unit pipe is connected to its tip portion.

Of course, a strong steel or concrete pipe is used in place of the plastic pipe when the pipe is to be run over land. Further, reinforced unit pipes are used for some special laying site where strong force will be applied, for example, draw pipe will be hanged in the seawater over a groove of the sea floor etc.

The fabrication of the unit pipes described above can be repeated for similar systems under construction nearby. Once the fabrication is complete, the various machines used to the fabrication, such as the injection-molding machine, the cylindrical mold, and the fusion splicing machine, are dismantled and transported to the next fabrication site. The vacated space is used for installing the core of the sea surface cooling system including evaporator, turbine, condenser, and pumps.

The total weight of a draw pipe having a length of 30 kilometers used in the system of the embodiment is 8,600 tons. The cost of the raw materials used to produce the pipe—PVC in this case—is estimated at about 3,300 dollars per ton. Further, by roughly estimating the costs for manufacturing and laying the pipe to be three times the price of its raw material, total construction costs can be estimated at 110 million dollars (3300×8600×4).

To produce 88 MW of mechanical power for driving the draw pump 6 by converting electric power at a conversion efficiency of 88%, 100 MW of electric power is necessary. The average cost for constructing a conventional steam power plant with 100 MW of output is estimated to be 20 billion yen (220 million dollars) in Japan, based on its unit price per KW. Construction costs for the core portion of the embodiment will be higher than that value because the system will require larger equipment due to the low steam temperature and, hence, steam pressure in OTEC. Conversely, the low steam pressure in OTEC will reduce the costs of fabricating and assembling the steam turbine, because great strength or precision in dimensions and positioning are not as critical as they are in super high pressure steam turbines used in the latest conventional power plants.

Thus, construction costs for the core portion are roughly estimated to be about 50 percent higher than that of the latest conventional steam power plant having the same output power, or about 330 million dollars. Therefore, the total construction costs are estimated to be 440 million dollars when accounting for the draw pipe. The total cost for constructing 63,000 sea surface cooling systems of the same scale as the embodiment described above is estimated to be about 28 trillion dollars (4.4×10⁸ $×6.3×10⁴=28×10¹² $). This is about 64% of the 44 trillion dollars estimated as the cost for reducing global CO₂ emissions by 40%, as described above.

As described above, the construction cost of the sea surface cooling system according to the present embodiment was estimated to be about twice that of a conventional steam power plant with 100 MW output. The output power from the reformed OTEC power plant according to the present embodiment was estimated to be about 40 MW, i.e. about 40% of the 100 MW output produced by the conventional steam power plant. This means that the construction cost per one MW or KW output of the reformed OTEC power plant is five times more expensive than that of the latest conventional steam power plant.

However, as the potential for dangerous thermal runaway explained above and summarized in the flowchart in FIG. 3 becomes better understood, we will come to the realization that discharging hot drainage into the sea surface is far more harmful than emitting CO₂ into the air. As a result, the price for trading emission rights for hot drainage will eventually be set much expensive than that for trading CO₂ emission rights. Therefore, in the near future, various expenditures and revenues such as the cost of buying fuel and CO₂ and hot drainage emission rights; various income such as compensation from government or trading market for the sea surface cooling effect will be taken into account in the total cost per unit output KWH. As a result, the total cost for power produced (KWH) in the reformed OTEC power plant will approach, or possibly even drop below, that of the conventional steam or atomic power plant.

### Second Embodiment

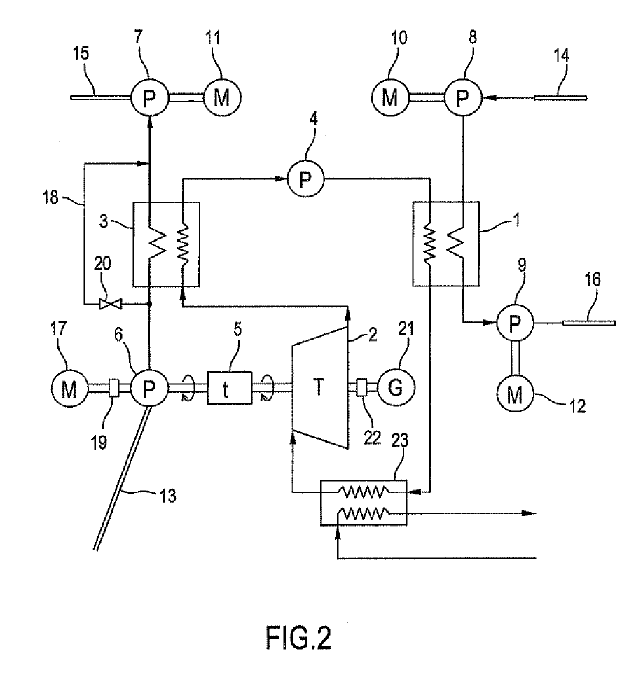

FIG. 2 is a block diagram showing a sea surface cooling system according to a second embodiment of the present invention. In FIG. 2, elements denoted by the same reference numbers used in FIG. 1 are the same elements as those denoted by the corresponding reference numbers and were already explained while referring to FIG. 1. Therefore, a duplicate explanation for these elements will be omitted. In the second embodiment, a generator 21 is newly installed and is coupled to the other end of turbine 2 through a coupling/decoupling unit 22.

A condensation-type solar power generating system employing a solar battery is constructed nearby. An example of this type of solar power generating system is disclosed in the preceding patent application US20100018567 by the present inventor. This system includes a two-dimensional reflector to condense solar energy on the solar cells located along its focal line, and means for discharging hot drainage, which was used to cool the solar cells, from the system. The hot drainage of the solar power generating system is supplied to a heat exchange unit 23 newly added to the system of the second embodiment for further heating the vapor of working fluid produced in evaporator 1 just before the vapor is introduced into turbine 2.

In the second embodiment, energy conversion efficiency of the system can be considerably improved by superheating the vapor of working fluid to increase temperature difference of the working fluid before and after expansion. Further, the increased mechanical output power from turbine 2 facilitates a smooth start-up operation for the system.

The system of the second embodiment is constructed near a conventional steam or atomic power plant in a middle latitude industrialized region. In such areas, the surface temperature of seawater is always high due to the large amount of hot drainage, used for cooling condensers, that is discharged from such conventional power plants. The system is also located in a coastal area along the Japan Sea. The surface temperature of the Japan Sea is rising three times faster than the global average. It is presumed that warm surface water in the shallow East China Sea having an average depth of only 190 meters is carried into the Japan Sea with the Tsushima Current. To utilize this hot surface seawater, a coastal area in the Northern Kyushu area on the Japan Sea would be a preferred location, although this is a middle latitude region located at latitude of about 34 degrees.

The system of the second embodiment works as a power plant for supplying electricity outside the system except during midnight when the demand for electricity is low the daytime. For this purpose, pump 6 and generator 21 are coupled to respective ends of the rotary axis of turbine 2. At midnight, the system functions as a sea surface cooling system by decoupling generator 21 from turbine 2 and supplying all the mechanical power to pump 6 to increase the flow of deep seawater.

<Conditions for Locations>

According to the above-described data analyzed by the Japan Meteorological Agency, there are numerous regions where abnormally hot weather occurs frequently. When selecting locations for the sea surface cooling system, it is preferable to give priority to such regions. In the northern hemisphere, coastal regions on the Caribbean Sea, Gulf of Mexico, Bay of Bengal, Arabian Sea, Persian Gulf, or Red Sea, for example, are preferable. In the southern hemisphere, coastal regions on the Java Sea and Banda Sea in Indonesia or the northern coast of the Mozambique Channel, for example, are preferable. It should be apparent that coastlines having a shallow continental shelf with deep or trench located nearby will be desirable, because the length of the drain pipe and therefore construction costs can be reduced considerably.

As described above, cold seawater pumped up from the deep sea is spread laterally by the sea current. However, it is also possible to implement the cooling operation at various locations by mounting the cooling system on a ship so that the system can be moved among various locations. In this case, the expensive long draw pipe is omitted and head loss and hence drawing power is reduced considerably.

OTEC power generation has many advantages. First, it is a clean energy resource and does not emit any CO₂. Second, there is an enormous supply of the energy resource capable of meeting all energy needs in the world. Third, it is a stable power source capable of supplying constant power 24 hours a day under any weather conditions and during any season.

<Desirable Side Effects of Sea Surface Cooling>

The OTEC sea surface cooling system has the desirable side effect of promoting the absorption of CO₂ into the cooled sea surface. A technology for producing cold artificial upwelling has been developed to promote the absorption of CO₂ into the sea surface. In this technology, a cold sea current or tidal wave flowing horizontally in the deep sea is forced upward by artificial structures installed on the seafloor.

To redirect the flow of cold seawater upward, an artificial mountain range is constructed in the sea by stacking concrete blocks on the seafloor. This system does not require any machine and, hence, requires no power and has great longevity. In the cold surface seawater produced by this upwelling, there are abundant plankton that absorb large amounts of CO₂ dissolved in the surface seawater, reducing the amount of CO₂ in the atmosphere. It is known that the cooler the sea water is, the greater the amount of CO₂ can dissolve in it.

Abundant plankton also attracts fish, producing good fishing grounds. This plan was once implemented under the support of the Fisheries Agency of Japan to increase food production. The sea surface cooling system of the present invention also has these desirable side effects as a matter of course.

What is claimed is:

1. A sea surface cooling system utilizing OTEC, comprising:
means for drawing surface seawater;
deep seawater pumping means, having a draw pipe, for pumping deep seawater through the draw pipe;
evaporator means for heating and vaporizing working fluid with a low boiling point by said drawn surface seawater;
mechanical power producing means for producing mechanical power by an expansion force of said vaporized working fluid;
condensation means for cooling said vaporized working fluid after said expansion by said pumped deep seawater to cause condensation;
means for circulating said condensed working fluid to said evaporator means; and
mechanical power transmission means for directly transmitting from said mechanical power producing means to said pumping means a mechanical power of variable ratio, without once converting said mechanical power into electric power, wherein said deep seawater pumping means is operated to pump deep seawater through the draw pip with said mechanical power.

2. The sea surface cooling system according to claim 1, wherein said variable ratio of mechanical power is increased gradually after the system is started.

3. The sea surface cooling system according to claim 2, wherein said variable ratio of mechanical power is maintained at one hundred percent only at midnight.

4. The sea surface cooling system according to claim 1, further comprising bypass means for bypassing a variable ratio of said drawn deep seawater as drainage.

5. The sea surface cooling system according to claim 1, wherein the system is located in an area of middle latitude adjacent to a conventional steam or atomic power generation plant.

6. The sea surface cooling system according to claim 1, wherein said draw pipe is formed of a polymer or plastic material with a diameter of a few meters and a thickness of a few tens of millimeters.

7. The sea surface cooling system according to claim 1, wherein the working liquid comprises ammonia and water.
